(19) United States
(12) Patent Application Publication
(10) Pub. No.: US 2013/0221773 A1
(43) Pub. Date: Aug. 29, 2013

(54) ELECTRIC MACHINE MODULE

(71) Applicant: Bradley D. Chamberlin, Pendleton, IN (US)

(72) Inventor: Bradley D. Chamberlin, Pendleton, IN (US)

(21) Appl. No.: 13/403,273

(22) Filed: Feb. 23, 2012

(51) Int. Cl. H02K 3/12; H02K 15/085; H02K 9/00

(52) U.S. Cl. 310/58; 310/201; 29/596

(57) ABSTRACT

Embodiments of the invention provide an electric machine module including a stator assembly. The stator assembly includes a stator core comprising a plurality of slots. Conductors can be at least partially disposed within the slots. The conductors can include leg portions and can be positioned so that at least some of the slots include a first leg portion, a second leg portion, a third leg portion, and a fourth leg portion. The stator assembly can include first clearance apertures defined by between circumferentially adjacent first leg portions, second clearance apertures that can be defined between circumferentially adjacent second leg portions, third clearance apertures that can be defined between circumferentially adjacent third leg portions, and fourth clearance apertures that can be defined between circumferentially adjacent fourth leg portions. In some embodiments, the second and third clearance apertures can comprise a greater circumferential size relative to the first and fourth clearance apertures.

### BACKGROUND

Some conventional electric machines include a stator assembly disposed around a rotor assembly. Some stator assemblies include a plurality of conductors positioned within a stator core. During operation of some electric machines, a current flows through the at least some of the conductors. In order to prevent potential short circuit events and or grounding incidents, some conventional configurations for stator assemblies require multiple insulation layers between and amongst the conductors. Moreover, during operation of some electric machines, heat energy can be generated by both the stator assembly and the rotor assembly, as well as some other components of the electric machine. The increase in heat energy produced by some elements of the electric machine can lead to inefficient machine operations.

### SUMMARY

Some embodiments of the invention provide an electric machine module including a stator assembly. In some embodiments, the stator assembly can include a stator core comprising a plurality of slots. In some embodiments, one or more conductors can be at least partially disposed within the slots. The conductors can include leg portions and can be positioned so that at least some of the slots include a first leg portion, a second leg portion, a third leg portion, and a fourth leg portion that extend from an end of the stator core. In some embodiments, the stator assembly can include first clearance apertures defined between circumferentially adjacent first leg portions, second clearance apertures that can be defined between circumferentially adjacent second leg portions, third clearance apertures that can be defined between circumferentially adjacent third leg portions, and fourth clearance apertures that can be defined between circumferentially adjacent fourth leg portions. In some embodiments, the second and third clearance apertures can comprise a greater circumferential size relative to the first and fourth clearance apertures.

### DESCRIPTION OF THE DRAWINGS

FIG. 1 is a perspective view of an electric machine module according to one embodiment of the invention.

FIG. 2 is a perspective view of an electric machine module according to one embodiment of the invention.

FIG. 3 is a perspective view of a stator assembly according to one embodiment of the invention.

FIG. 4 is front view of a stator lamination according to one embodiment of the invention.

FIG. 5 is a perspective view of a conductor according to one embodiment of the invention.

FIGS. 6A and 6B are cross-sectional views of a slot according to some embodiments of the invention.

FIG. 7 is an isometric perspective view of a stator assembly according to one embodiment of the invention.

FIG. 8 is a cross-sectional view of an inner perimeter the stator assembly of FIG. 7.

FIG. 9 is another perspective view of the stator assembly of FIG. 7.

FIG. 10 is a cross-sectional view of an outer perimeter of the stator assembly of FIG. 7.

FIG. 11 is a cross-sectional view of an outer perimeter of a stator assembly of FIG. 7 that includes only first and second leg portions.

FIG. 12 is an expanded isometric view of conductors of the stator assembly of FIG. 7.

FIG. 13 is an expanded isometric view of conductors of the stator assembly shown in FIG. 11.

FIG. 14 is a radially outer perspective cross-sectional view of a stator assembly including only first and second leg portions according to some embodiments of the invention.

FIG. 15 is radially inner perspective cross-sectional view of the stator assembly of FIG. 14.

FIG. 16 is a radially outer perspective cross-sectional view of a stator assembly including only third and fourth leg portions according to some embodiments of the invention.

FIG. 17 is a radially inner perspective cross-sectional view of the stator assembly of FIG. 16.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

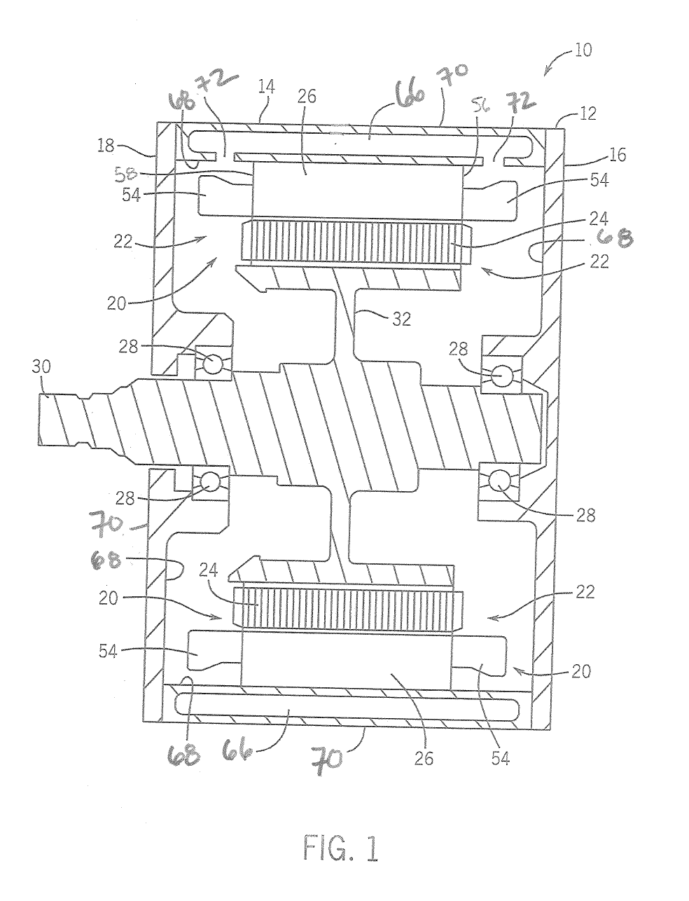

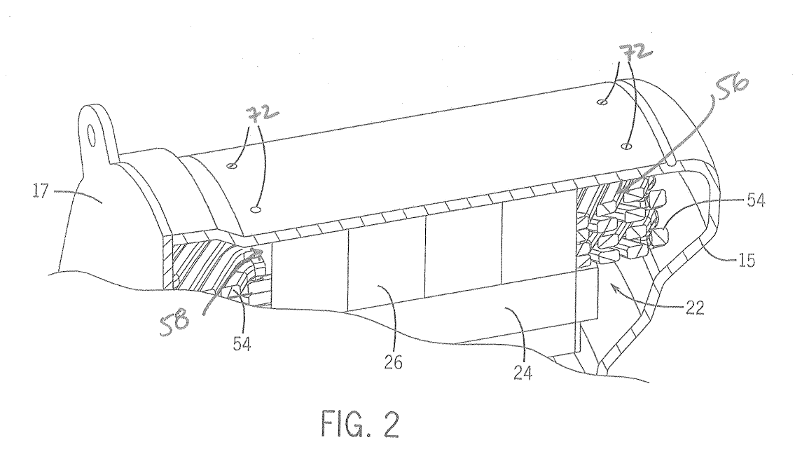

FIGS. 1 and 2 illustrate an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments, the housing 12 can comprise a substantially cylindrical canister 15 coupled to an end cap 17, as shown in FIG. 2. Further, in some embodiments, the housing 12 can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can include a rotor assembly 24, a stator assembly 26, and bearings 28, and can be disposed about a shaft 30. As shown in FIG. 1, the stator assembly 26 can substantially circumscribe at least a portion of the rotor assembly 24. In some embodiments, the rotor assembly 24 can also include a rotor hub 32 or can have a “hub-less” design (not shown).

In some embodiments, the electric machine 20 can be operatively coupled to the housing 12. For example, the electric machine 20 can be fit within the housing 12. In some embodiments, the electric machine 20 can be fit within the housing 12 using an interference fit, a shrink fit, other similar friction-based fits that can at least partially operatively couple the machine 20 and the housing 12. For example, in some embodiments, the stator assembly 26 can be shrunk fit into the module housing 12. Further, in some embodiments, the fit can at least partially secure the stator assembly 26, and as a result, the electric machine 20, in axial, radial and circumferential directions. In some embodiments, during operation of the electric machine 20 the fit between the stator assembly 26 and the housing 12 can at least partially serve to transfer torque from the stator assembly 26 to the housing 12. In some embodiments, the fit can result in a generally greater amount of torque retained by the module 10.

The electric machine 20 can be, without limitation, an electric motor, such as a hybrid electric motor, an electric generator, or a vehicle alternator. In one embodiment, the electric machine 20 can be a High Voltage Hairpin (HVH) electric motor, an interior permanent magnet electric motor, or an induction motor for hybrid vehicle applications.

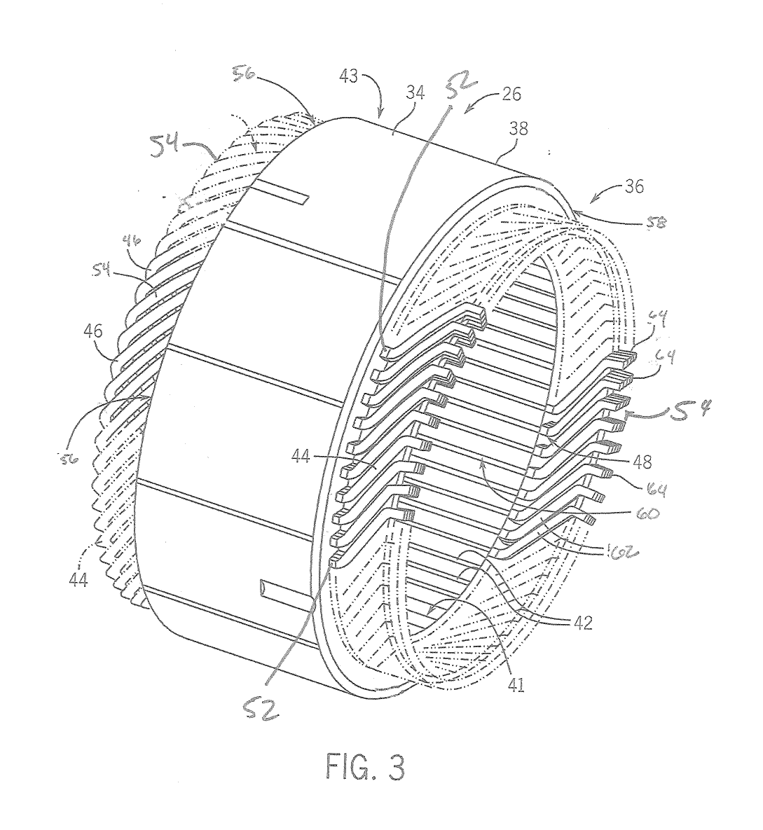

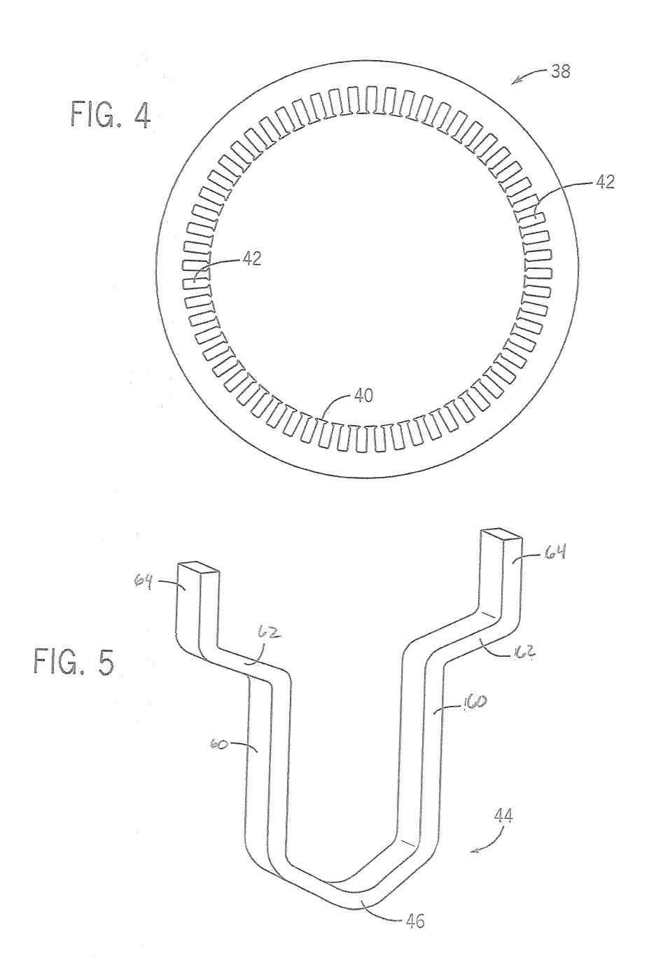

As shown in FIG. 3, in some embodiments, the stator assembly 26 can comprise a stator core 34 and a stator winding 36 at least partially disposed within a portion of the stator core 34. For example, in some embodiments, the stator core 34 can comprise a plurality of laminations 38. Referring to FIG. 4, in some embodiments, the laminations 38 can comprise a plurality of substantially radially-oriented teeth 40. In some embodiments, as shown in FIG. 3, when at least a portion of the plurality of laminations 38 are substantially assembled, the teeth 40 can substantially align to define a plurality of slots 42 that are configured and arranged to support at least a portion of the stator winding 36. As shown in FIG. 4, in some embodiments, the laminations 38 can include sixty teeth 40, and, as a result, the stator core 28 can include sixty slots 42. In other embodiments, the laminations 38 can include more or fewer teeth 40, and, accordingly, the stator core 34 can include more or fewer slots 42. Moreover, in some embodiments, the stator core 34 can comprise an inner perimeter 41 and an outer perimeter 43. For example, in some embodiments, the stator core 34 can comprise a substantially cylindrical configuration so that the inner and outer perimeters 41, 43 can comprise inner and outer diameters, respectively. However, in other embodiments, the stator core 34 can comprise other configurations (e.g., square, rectangular, elliptical, regular or irregular polygonal, etc.), and, as a result, the inner and outer perimeters 41, 43 can comprise other dimensions.

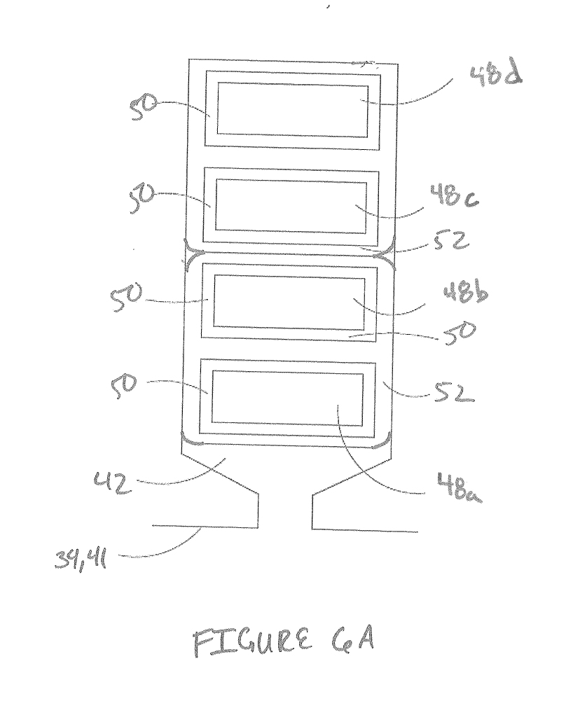

In some embodiments, the stator winding 36 can comprise a plurality of conductors 44. In some embodiments, the conductors 44 can comprise a substantially segmented configuration (e.g., a hairpin configuration), as shown in FIGS. 3 and 5. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wave shape, a curved shape, and other shapes. Additionally, in some embodiments, as shown in FIG. 5, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc. In some embodiments, the conductors 44 can comprise other configurations (e.g., substantially non-segmented configuration).

In some embodiments, the stator assembly 26 can comprise one or more insulating members, apparatuses, and/or other structures configured and arranged to provide mechanical, electrical, and physical insulation to some portions of the stator assembly 26. In some embodiments, at least a portion of some of the conductors 44 can comprise a first insulation 50. For example, in some embodiments, the first insulation 50 can comprise a resinous material such as an epoxy or an enamel that can be reversibly or irreversibly coupled to at least a portion of the conductors 44. In some embodiments, because an electrical current circulates through the conductors 44 during operation of the electric machine 20, the first insulation 50 can function, at least in part, to substantially prevent short circuits and/or grounding events between neighboring conductors 44 and/or conductors 44 and the stator core 34.

In some embodiments, the first insulation 50 can comprise a shrunk-fit structure coupled to at least some of the conductors 44 so that the first insulation 50 is retained when the conductors 44 are disposed within the stator core 28. In some embodiments, the first insulation 50 can be wrapped, wound, or otherwise disposed on, or coupled to, the conductors (e.g., via an adhesive). In some embodiments, as discussed further below, at least a portion of the conductors 44 can function suitably without some or all of the first insulation 50.

In some embodiments, the conductors 44 can be generally fabricated from a substantially linear conductor 44 that can be configured and arranged to a shape substantially similar to the conductor in FIG. 5. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44. In some embodiments, at least a portion of the conductors 44 can be configured into a desired shape after coupling of the first insulation 50 to the conductors 44. Although, in some embodiments, at least a portion of the conductors 44 can be configured (e.g., bent, pushed, pulled, etc.) into a desired shape (e.g., a hairpin) and then the first insulation 50 can be coupled to the conductors 44.

In some embodiments, the stator assembly 26 can comprise a second layer of insulation. In some embodiments, the second layer of insulation can comprise at least one slot member 52. In some embodiments, the stator assembly 26 can comprise at least one slot member 52 disposed in one or more of the slots 42. For example, one or more slot members 52 can be disposed in some or all of the slots 42. In some embodiments, each slot 42 can comprise at least one slot member 52. In some embodiments, at least a portion of the slot members 52 can comprise a substantially cylindrical shape. In some embodiments, the slot members 52 can comprise other shapes, such as square, rectangular, hemispherical, regular or irregular polygonal, etc. In some embodiments, at least a portion of the slot members 52 can comprise any shape desired and/or needed by the manufacturer or user. Moreover, in some embodiments, the slot members 52 can be configured and arranged to receive at least a portion of one or more conductors 44, as described in further detail below.

In some embodiments, the slot member 52 can comprise materials that can resist abrasion, can provide electrical and/or mechanical insulation, can comprise thermally-conductive properties, and/or can comprise other properties desired by a manufacturer or user. For example, in some embodiments, at least a portion of the slot members 52 can comprise materials such as Nomex®, Kapton®, Kevlar®, Mylar®, polyimides, polyamides, polyester, polyamideimide, polyethylene terephthalate film, or other materials. In some embodiments, the slot member 52 can comprise a composite of some or all of the previously mentioned materials, such as a Nomex®-Katpton® composite.

In some embodiments, as shown in FIG. 3, at least a portion of the conductors 44 can be positioned substantially within the slots 42. For example, in some embodiments, the stator core 34 can be configured so that the plurality of slots 42 are substantially axially arranged. In some embodiments, the leg portions 48 can be inserted into the slots 42 so that at least some of the leg portions 48 can axially extend through the stator core 34. In some embodiments, the leg portions 48 can be inserted into adjacent slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 34 so that at least some of the turn portions 46 of the conductors 44 axially extend from the stator core 34 at an insertion end 56 of the stator assembly 26 and at least some of the leg portions 48 axially extend from the stator assembly 26 at a weld end 58 of the stator core 34. In some embodiments, at least a portion of the conductor 44 regions that axially extend from the stator assembly 26 at the ends 56, 58 can comprise stator end turns 54.

In some embodiments, one or more slot members 52 can be disposed within some or all of the slots 42 during assembly of the module 10. In some embodiments, the slot members 52 can be disposed within the slots 42 prior to one or more of the conductors 44 being disposed within the stator core 34. For example, in some embodiments, the slot members 52 can be positioned within the slots 42 so that at least a portion of some of the conductors 44 (e.g., the leg portions 48) can be at least partially disposed within the slot members 52. By way of example only, in some embodiments, one or more slot members 52 can be disposed within each of the slots 42 so that the slot members 52 can receive at least a portion of each of the conductors 44.

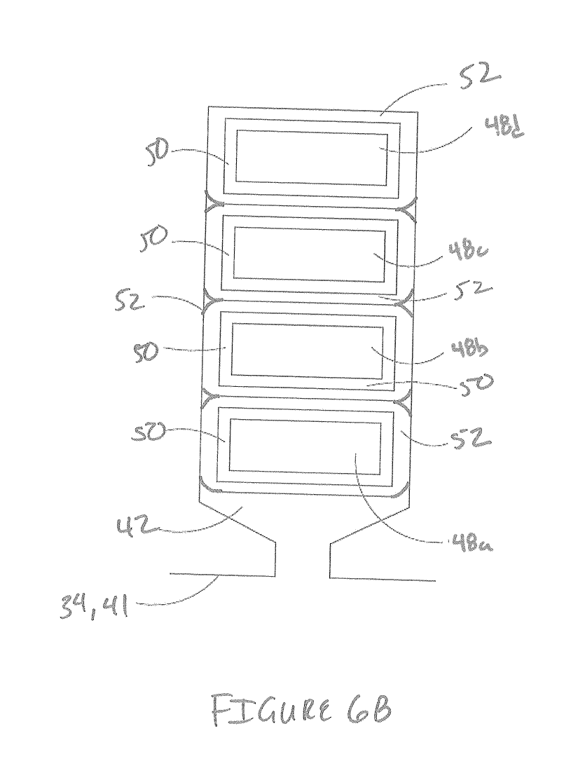

Moreover, in some embodiments, one slot member 52 can receive one or more conductors 44. In some embodiments, one slot member 52 can be configured and dimensioned to receive two or more conductors 44. For example, in some embodiments, at least a portion of the slot members 52 can be configured and arranged to receive two conductors 44 (e.g., a leg portion 48 of two different conductors 44 or both leg portions 48 of the same conductor 44), as shown in FIG. 6A. As a result, in some embodiments, at least a portion of the slots 42 can comprise four conductors 44 and two slot members 52 (e.g., portions of two conductors 44 disposed in a slot member 52). In some embodiments, at least a portion of the slots 42 can comprise the same number of slot members 52 as conductors 44. For example, in a slot 42 including portions of four conductors 44, the slot 42 can comprise four or more slot members 52, as shown in FIG. 6B. Furthermore, in some embodiments, the stator assembly 26 can comprise any combination of any of the foregoing slot member 52/conductor 44 ratios. For example, some slots 42 can comprise four slot members 52 and four conductors 44, some slots 42 can comprise two slot members 52 and four conductors 44, and some slots can comprise one or more than one slot members 52 and four conductors 44. As previously mentioned, the use of four conductors 44 is exemplary and other numbers of conductors 44 (e.g., one, two, six, eight, etc.) can be disposed within the slots 42.

In some embodiments, at least some of the leg portions 48 can comprise multiple regions. In some embodiments, the leg portions 48 can comprise in-slot portions 60, angled portions 62, and connection portions 64. In some embodiments, as previously mentioned, the leg portions 48 can be disposed in the slots 42 and some regions of the leg portions 48 (e.g., the in-slot portions 60) can be at least partially received within the slot members 52. Moreover, the leg portions 48 can, at least, axially extend from the insertion end 56 to the weld end 58. In some embodiments, after insertion, at least some of the leg portions 48 positioned within the stator core 34 can comprise the in-slot portions 60.

In some embodiments, at least some regions of the leg portions 48 extending from stator assembly 26 at the weld end 58 can comprise the angled portions 62 and the connection portions 64. In some embodiments, after inserting the conductors 44 into the stator core 34, the leg portions 48 extending from the weld end 58 can undergo a twisting process that can lead to the creation of the angled portions 62 and the connection portions 64, as described below.

For example, as previously mentioned, in some embodiments, four leg portions 48 from four conductors 48 can be disposed in some or all of the slots 42. As shown in FIGS. 6A and 6B, in some embodiments, the leg portions 48 can be radially arranged so that a first leg portion 48a is adjacent to the inner perimeter 41 of the stator core, a second leg portion 48b is immediately radially outward from the first leg portion 48a, a third leg portion 48c is immediately radially outward from the second leg portion 48b, and a fourth leg portion 48d is immediately radially outward from the third leg portion 48c and substantially adjacent to the outer perimeter 43 of the stator core 34. However, as previously mentioned, the stator assembly 26 can comprise greater or lesser numbers of leg portions 48 in some or all of the slots 42.

During the twisting process, leg portions 48a-48d can be twisted to form the angled portions 62 and the connection portions 64 and so that the connection portions 64 of neighboring conductors 44 can be coupled together to form one or more stator windings 36. During a conventional twisting process, some or all of the leg portions 48a-48d in some or all of the slots 42 can be moved (e.g., twisted) so that adjacent conductors 44 can be coupled together. For example, in some conventional twisting processes, the first leg portion 48a in a first slot 42 and the second leg portion 48b in a second slot (e.g., the second slot 42 disposed a distance apart from the first slot 42 of about one magnetic pole pitch) can each be moved a substantially equal distance toward each other (i.e., about one half of a magnetic pole pitch). By way of example only, in some conventional twisting processes, the first leg portion 48a can be moved a distance of approximately three slots in a clockwise direction and the second leg portion 48b can be moved a distance of approximately three slots in a counter-clockwise direction or vice versa. As a result, the conventional twisting process locates the angled portions 62 at a more axially inward position and the connection portions 64 at a more axially outward position, similar to what is illustrated in FIG. 3. Moreover, after the conventional twisting process, the connection portions 64 of the first and second leg portions 48a, 48b can be substantially immediately adjacent to each other and these connection portions 64 can be coupled together to form a portion of the stator winding 36. In some embodiments, the connection portions 64 can be coupled via welding, brazing, soldering, melting, adhesives, or other coupling methods.

Additionally, using a conventional twisting process, the third and fourth leg portions 48c, 48d can be similarly configured. For example, the third leg portion 48c in the first slot 42 and the fourth leg portion 48d in the second slot can each be moved a substantially equal distance toward each other. By way of example only, in some conventional twisting processes, the third leg portion 48c can be moved a distance of approximately three slots in a clockwise direction and the fourth leg portion 48d can be moved a distance of approximately three slots in a counter-clockwise direction or vice versa. As a result, similar to the first and second leg portions 48a, 48b, the conventional twisting process locates the angled portions 62 of the third and fourth leg portions 48c, 48d at a more axially inward position and the connection portions 64 at a more axially outward position, similar to what is illustrated in FIG. 3. Moreover, after the conventional twisting process, the connection portions 64 of the third and fourth leg portions 48c, 48d can be substantially immediately adjacent to each other and these connection portions 64 can be coupled together to form a portion of the stator winding 36. Some or all of the leg portions 48a-48d extending from some or all of the remaining slots 42 can be configured in a substantially similar manner to form one or more stator windings 36.

In some embodiments, the first insulation 50 can at least partially wear down and/or become deformed as a result of the twisting process. For example, in some embodiments, pressure points created by the twisting process can create areas of the first insulation 50 that receive more mechanical stress relative to other portions of the first insulation 50. Over the course of the life of the module 10, the first insulation 50 can wear, and, under some circumstances, the first insulation 50 can eventually become compromised. As a result of wear of the first insulation 50, in some embodiments, bare conductors 44 (e.g., bare copper or bare copper-containing materials) can contact each other, the stator core 34, the housing 12, or other elements, which can lead to malfunctioning of the module 10 (e.g., short circuit events, grounding events, etc.).

Moreover, in order to at least partially reduce the risk of first insulation 50 wear and to at least partially reduce the risk of contact between regions of the conductors 44 (e.g., the angled portions 62 or other regions of the leg portions 48a-48d), it can be beneficial to provide a circumferential gap and/or aperture between the conductors 44 extending from the stator core 34 at the weld end 58. By providing a clearance aperture 45 between adjacent conductors 44 (e.g., circumferentially adjacent conductor 44 portions), the chance of contact between neighboring conductors 44 can be reduced, and, accordingly, the chance of wearing of the insulation 50 and subsequent grounding and/or short circuit events can also be reduced. Moreover, the extent of twisting can be at least partially correlated with the size of the clearance aperture 45. For example, the greater the distance that the leg portions 48 are twisted from their original positions (e.g., substantially linear and extending from the stator core 34), the lesser the size of the clearance aperture 45 between adjacent conductors 44 and vice versa.

Twisting of the leg portions 48a-48d can define multiple clearance apertures 45. For example, after twisting the conductors 44, a plurality of first clearance apertures 45a can be defined between circumferentially adjacent first leg portions 48a, a plurality of second clearance apertures 45b can be defined between circumferentially adjacent second leg portions 48b, a plurality of third clearance apertures 45c can be defined between circumferentially adjacent third leg portions 48c, and a plurality of fourth clearance apertures 45d can be defined between circumferentially adjacent fourth leg portions 48d. Using some conventional twisting processes, the clearance apertures 45a-45d can comprise a substantially similar size (e.g., circumferential size, such as width, length, depth, volume, etc.).

Additionally, in order to assess the clearance apertures 45 between adjacent conductors 44, a visual, optical, or other form of inspection can be carried out using a manual or automatic technique. For example, after manufacture of all or some of the stator assembly 26, the conductors 44 can be inspected (e.g., automatically and/or manually) to assess the quality, size, and/or nature of the clearance apertures 45 between the conductors 44. For example, the radially outer layers of conductors 44 (i.e., the first and fourth leg portions 48a, 48d) can be inspected to assess the clearance apertures 45a, 45d (e.g., the circumferential size of the clearance apertures 45) between the conductors 44. The radially inner layers of conductors 44 (i.e., the second and third leg portions 48b, 48c) can also be inspected to assess the clearance apertures 45b, 45c between the conductors 44. However, it may be more difficult to inspect the radially inner layers of conductors 44 relative to inspecting the radially outer layers of conductors 44 because of the obstruction created by the radially outer layers of conductors 44. After inspection of the clearance apertures 45, if some or all of the clearance apertures 45 are judged to be of an insufficient size (e.g., too small so that there is an increased risk of insulation 50 wear and/or contact between conductors 44), the stator assembly 26 can be altered to ensure that the clearance apertures 45 are of a sufficient size (e.g., conductor 44 repair) or the stator assembly 26 can be prevented from being installed in an electric machine module 10 (i.e., removed from the product supply line). As a result of the inspection, producers can ensure that stator assemblies 26 are of sufficient quality (e.g., the clearance aperture 45 are of a size sufficient to at least partially reduce the risk of module 10 malfunctions).

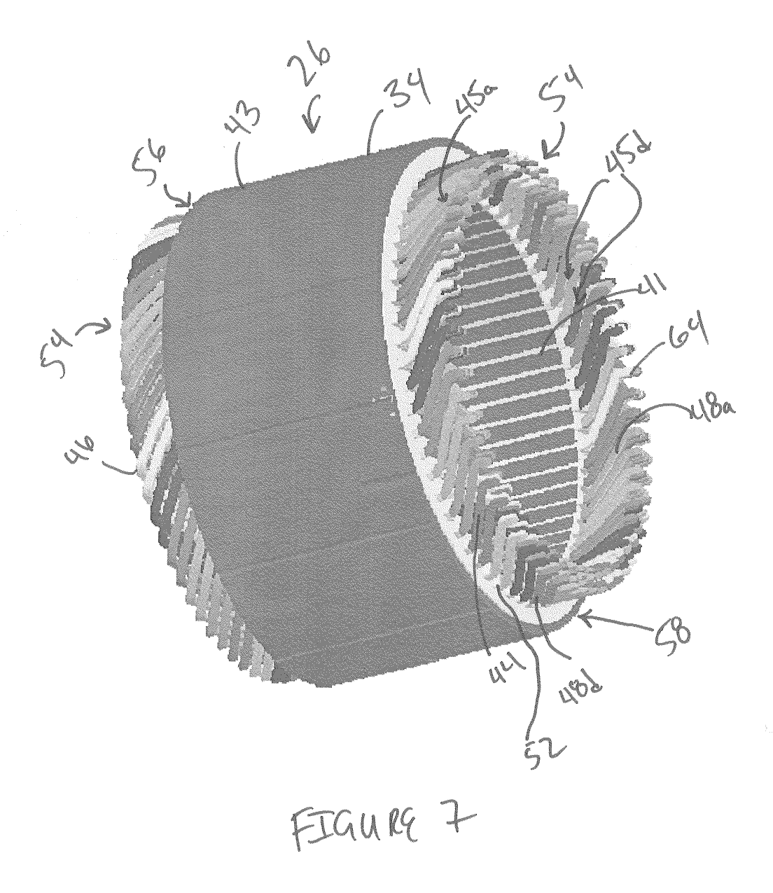

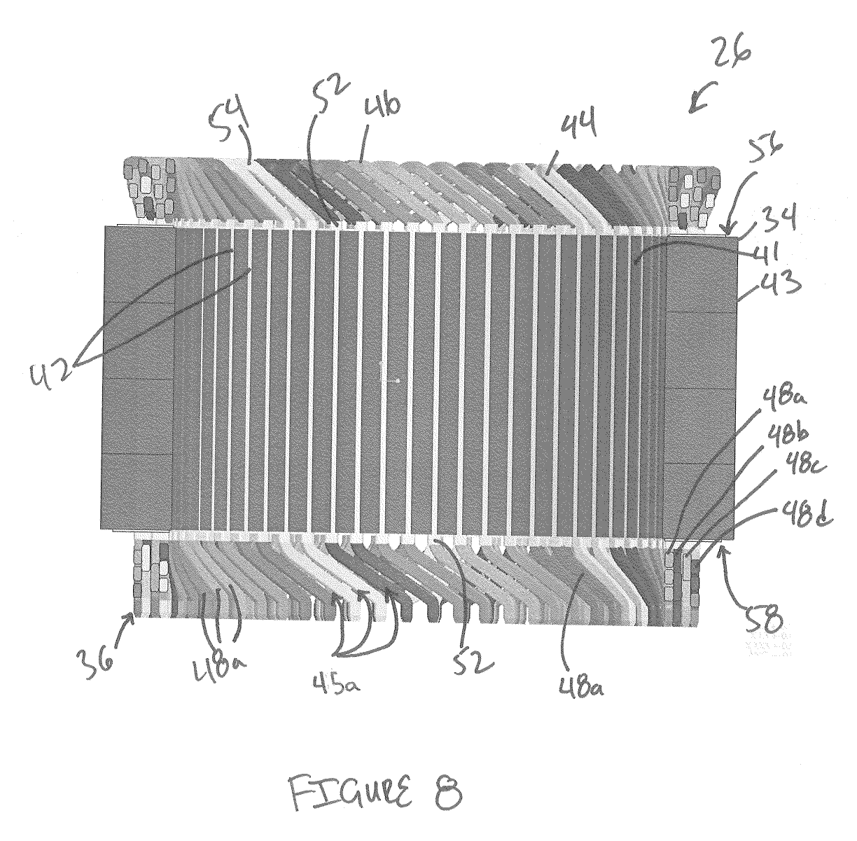

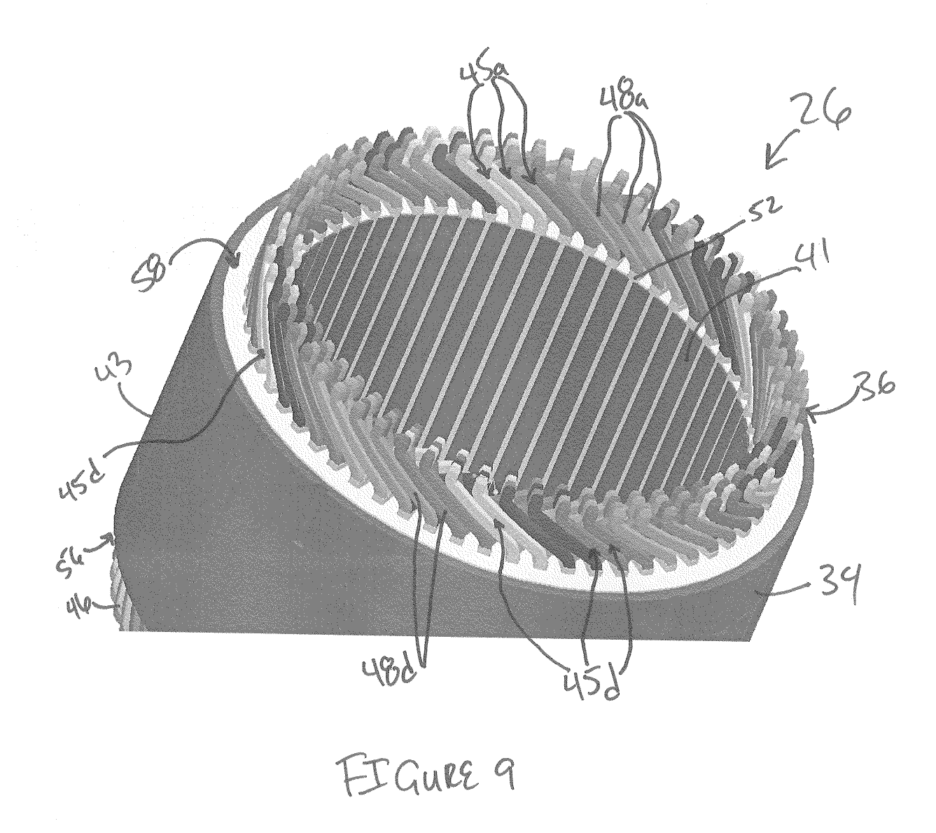

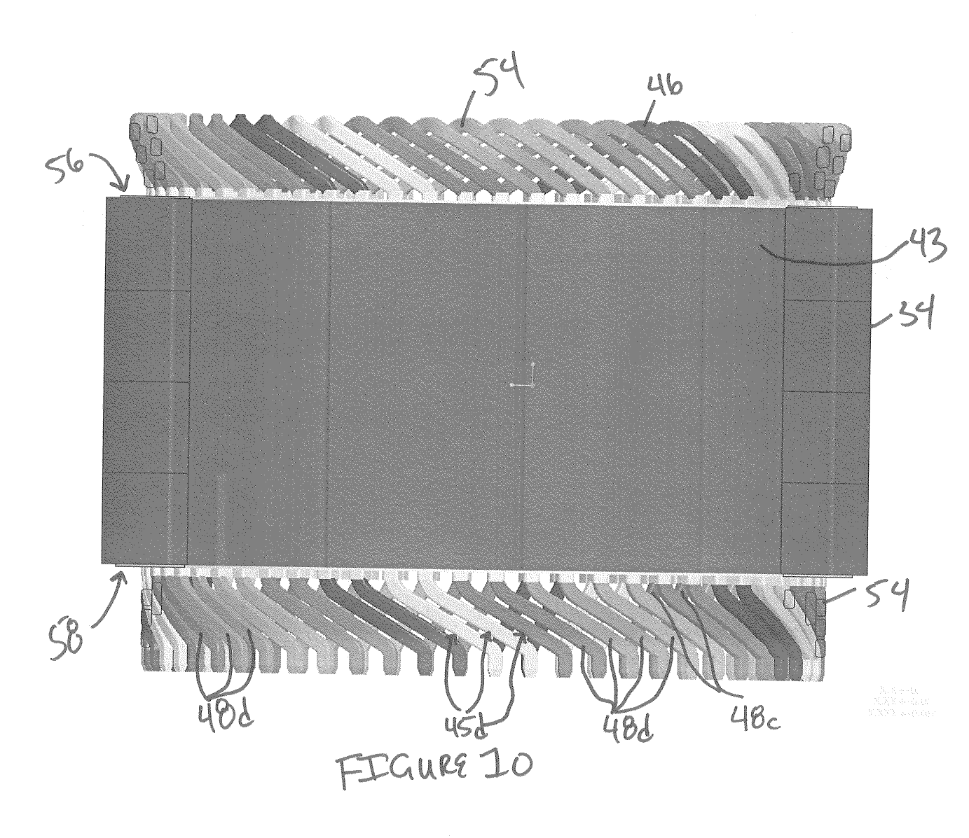

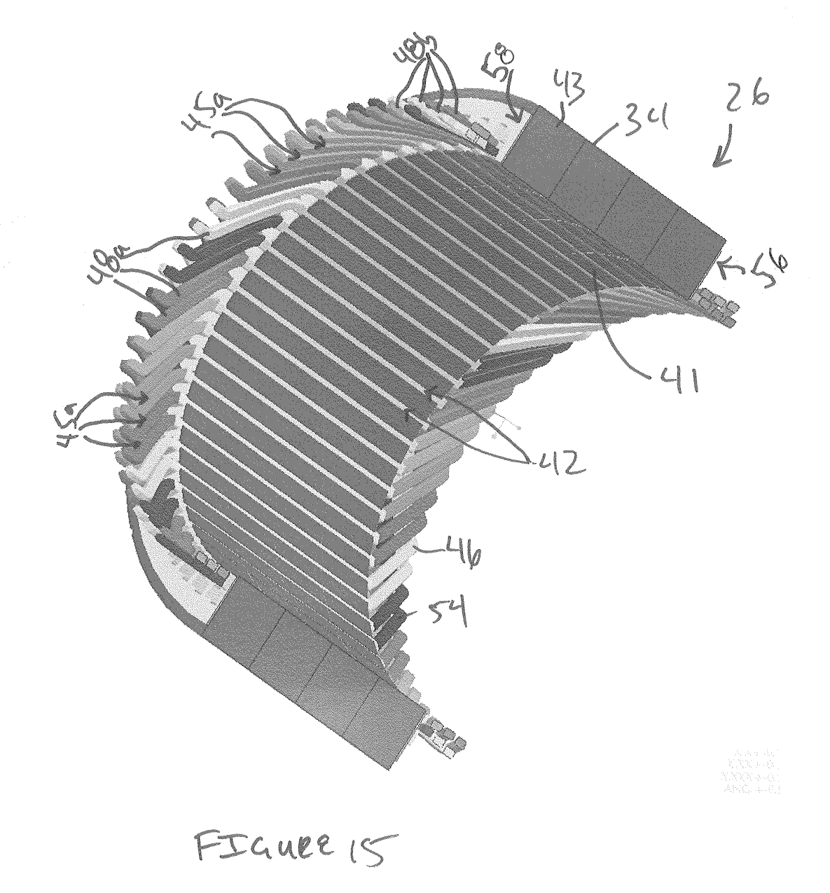

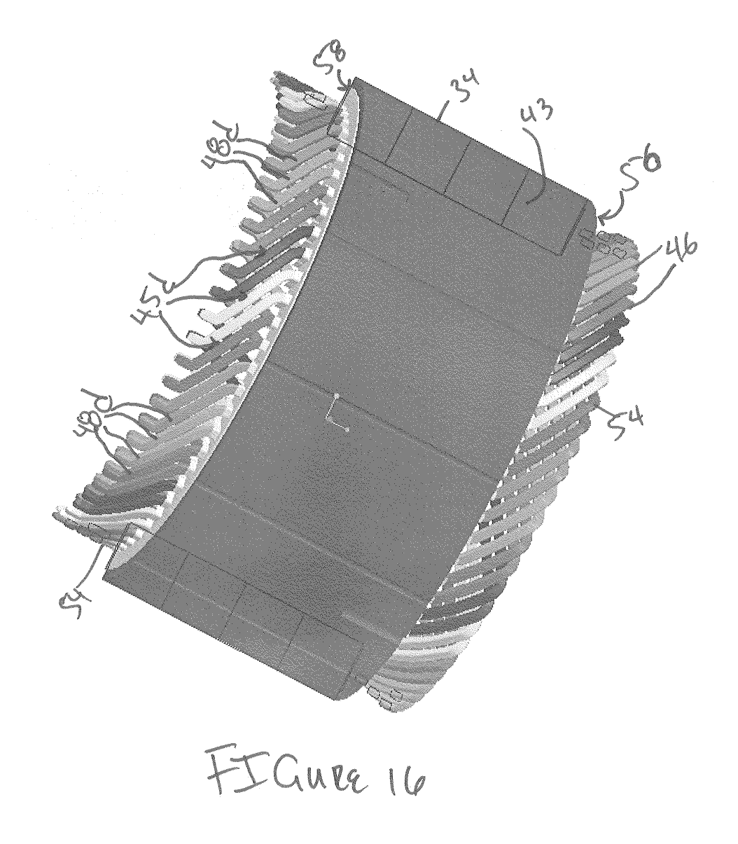

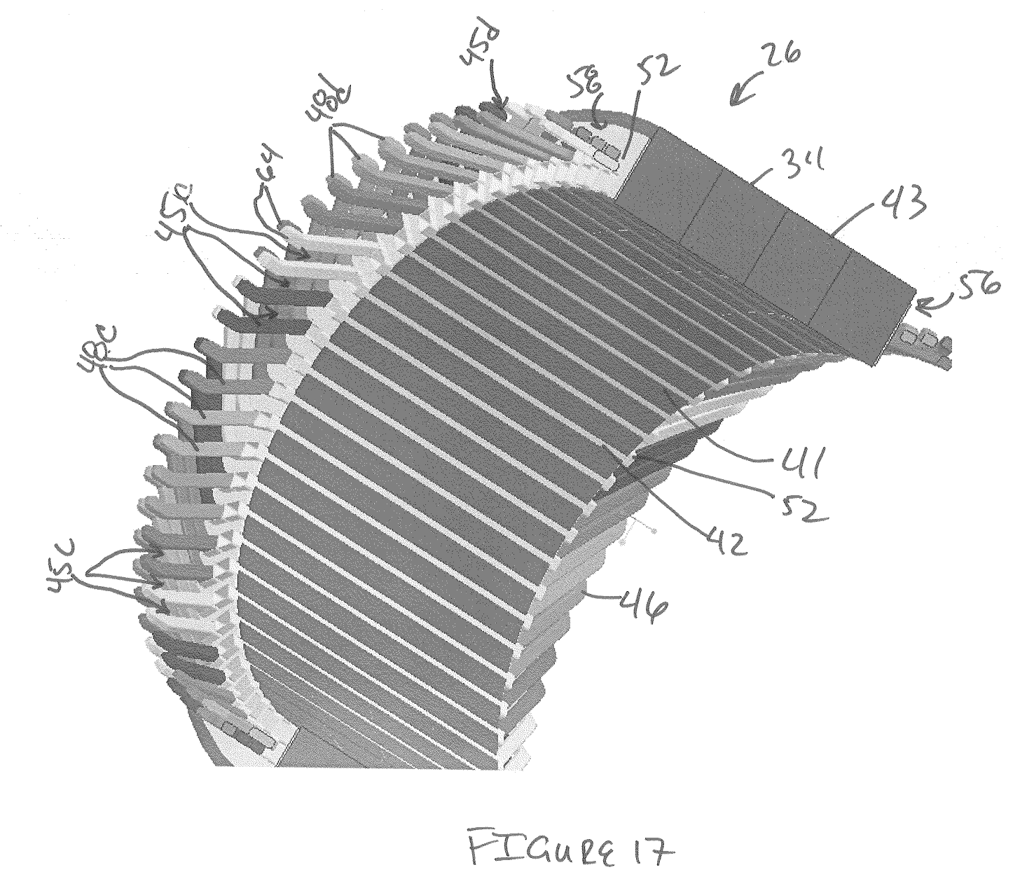

According to some embodiments of the invention, the twisting process can comprise alternative processes to alter the clearance apertures 45 and/or the chances of recognizing insufficiently dimensioned clearance apertures 45. In some embodiments, the leg portions 48a-48d can be twisted different distances (e.g., circumferential distances) relative to the conventional twisting process. In some embodiments, the radially outer leg portions 48 (i.e., the first and fourth leg portions 48a, 48d) can be twisted a greater circumferential distance relative to the conventional twisting process and the radially inner leg portions 48 (i.e., the second and third leg portions 48b, 48c) can be twisted a lesser circumferential distance relative to the conventional twisting process. In some embodiments, in order to twist the conductors 44 approximately the same distance (e.g., six slots 42, one magnetic pole pitch, or any other distance), in lieu of twisting each of the leg portions 48a-48d by a distance equivalent to three slots 42 (e.g., the first and third leg portions 48a, 48c twisted a distance of about three slots in a clockwise direction and the second and fourth leg portions 48b, 48d twisted a distance of about three slots in a counter-clockwise direction or vice versa), the first and fourth leg portions 48a, 48d can be twisted a first circumferential distance and the second and third leg portions 48b, 48c can be twisted a second circumferential distance, as shown in FIGS. 7-17. For example, in some embodiments, the first and fourth leg portions 48a, 48d can be twisted a distance equivalent to about four slots 42 and the second and third leg portions 48b, 48c can be twisted a distance equivalent to about two slots 42, as shown in FIGS. 10-17. As a result of this configuration, the conductors 44 can be twisted the same overall distance (e.g., six slots 42), but can exhibit improvements over conductors 44 twisted using the conventional twisting process.

In some embodiments, by twisting the first and fourth leg portions 48a, 48d a distance equivalent to about four slots 42 and twisting the second and third leg portions 48b, 48c a distance equivalent to about two slots 42, confidence in the size of at least some clearance apertures 45 can be at least partially improved. In some embodiments, the first and fourth leg portions 48a, 48d can be twisted in clockwise and counter-clockwise directions, respectively. In some embodiments, the second and third leg portions 48b, 48c can be twisted in counter-clockwise and clockwise directions, respectively. Furthermore, the first and fourth clearance apertures 45a, 45d defined between circumferentially adjacent first and fourth leg portions 48a, 48d, respectively, can be the easiest clearance apertures 45 to visually inspect because these clearance apertures 45a, 45d are the most adjacent to the inner and outer perimeters 41, 43 of the stator assembly 26 (i.e., a visual path to the first and fourth clearance apertures 45a, 45d is less obstructed than a visual path to the second and third clearance apertures 45b, 45c). As a result, any regions of the stator winding 36 that include clearance aperture 45 of potentially insufficient size can be noted during inspection and either the conductors 44 can be adjusted or the stator assembly 26 can be removed from production so that it is not used in downstream applications, as previously mentioned. Moreover, the first and fourth leg portions 48a, 48d can be twisted to a greater extent (e.g., four slots 42) relative to the second and third leg portions 48b, 48c because these leg portions 48a, 48d and clearance apertures 45a, 45d can be more readily inspected for any potential difficulties associated with the clearance aperture 45a, 45d size (e.g., it can be easier to detect any clearance aperture 45a, 45d that may be sized too small) that could lead to module 10 malfunctions.

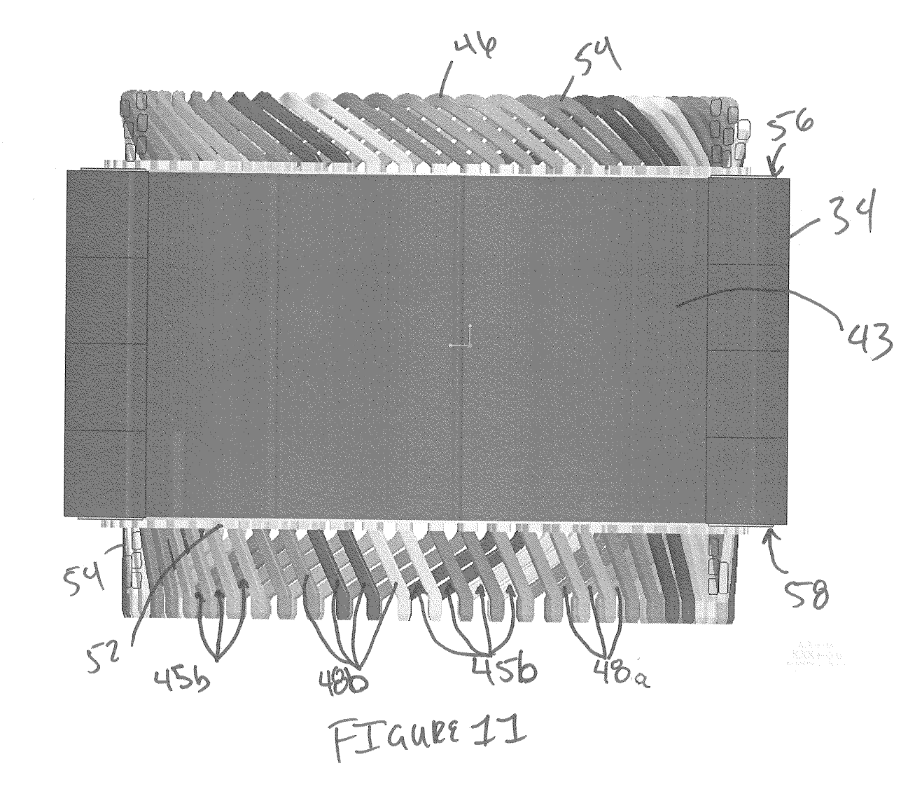

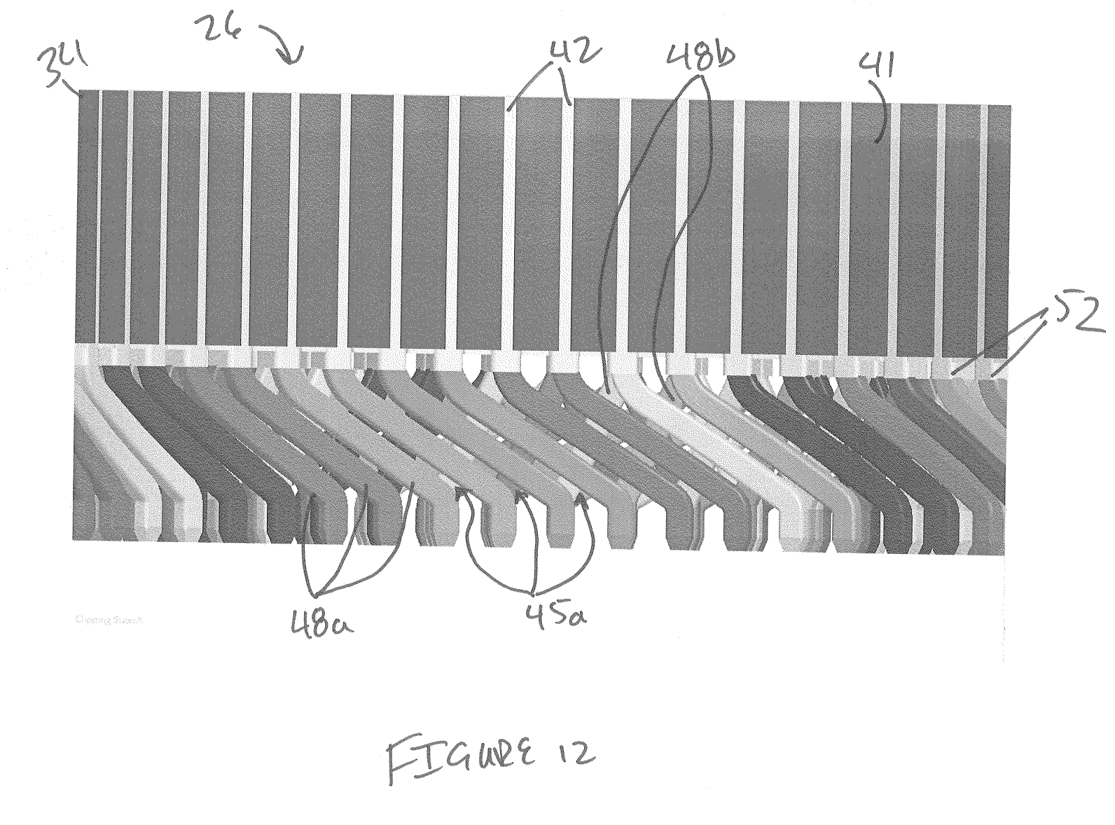

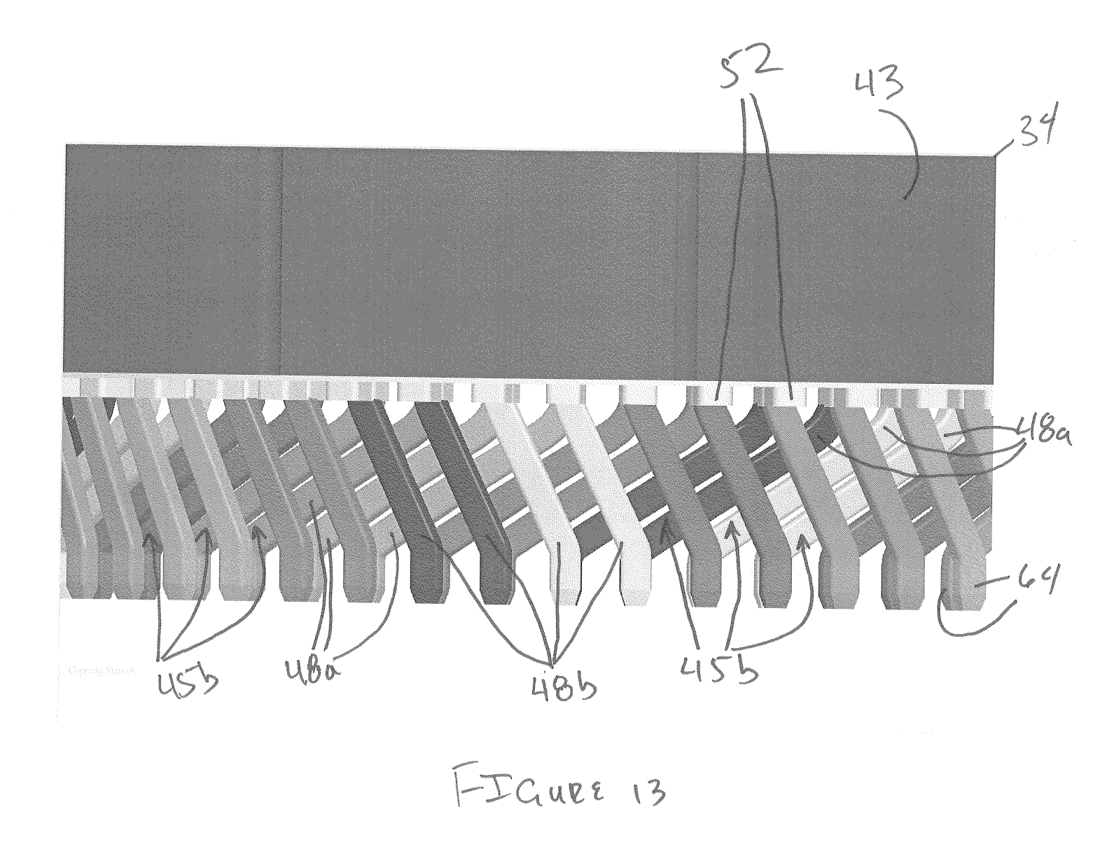

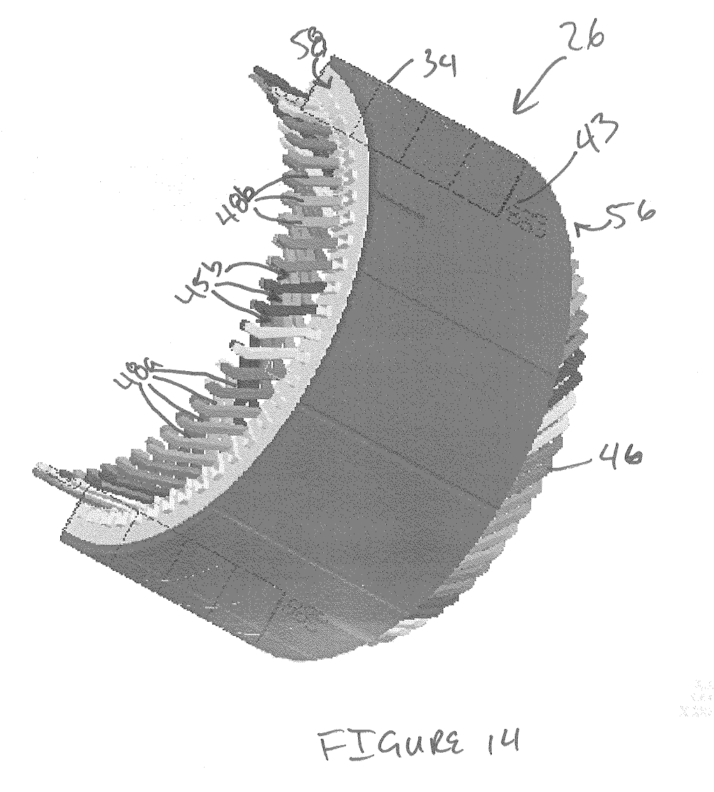

For example, in some embodiments, the clearance apertures 45b between the second leg portions 48b (and third leg portions 48c, not shown), as shown in FIGS. 11 and 13, can comprise a greater circumferential size relative to the clearance apertures 45a of the first leg portions 48a (and fourth leg portions 48d, not shown), as shown in FIGS. 10 and 12. As a result of the greater circumferential size, it is not as necessary for manufacturers to inspect the clearance gaps 45b, 45c between the second and third leg portions 48b, 48c and there can be a reduced risk of contact between the second and third leg portions 48b, 48c because of the increased circumferential size of the clearance gaps 45b, 45c. Additionally, the clearance gaps 45a, 45d between the first and fourth leg portions 48a, 48d can comprise a lesser circumferential size because it can be easier to detect insufficiencies in clearance gap 45 size because of the first and fourth leg portions 48a, 48d positioning adjacent to the inner and outer perimeters 41, 43. FIGS. 14-17 illustrate a substantially similar configuration and substantially similar clearance gaps 45.

Furthermore, by twisting the second and third leg portions 48b, 48c the distance of about two slots 42, confidence in the size of the clearance aperture 45b, 45c can be further improved. As previously mentioned, the extent of twisting can be at least partially correlated with the size of the clearance apertures 45, as shown in FIGS. 14-17. For example, a reduced twisting distance can at least partially correlate with a clearance aperture 45 of greater circumferential size, and, accordingly, an at least partially reduced risk for grounding and/or short circuit events. Moreover, although the second and third leg portions 48b, 48c cannot be as readily inspected as the first and fourth leg portions 48a, 48d, because of the lesser twisting distance of the second and third leg portions 48b, 48c (i.e., greater circumferential size of the clearance gaps 45b, 45c), manufacturers and/or end users can have greater confidence in the size and dimensions of the clearance apertures 45b, 45c circumferentially defined between the second and third leg portions 48b, 48c, as shown in FIGS. 10, 11, and 13-17. Overall, in some embodiments, the combination of twisting the first and fourth leg portions 48a, 48d the distance equivalent to about four slots 42 and twisting the second and third leg portions 48b, 48c the distance equivalent to about two slots 42 can provide a clearance apertures 45b, 45c of increased size between neighboring second and third leg portions 48b, 48c and an ability to readily observe the clearance apertures 45a, 45d between the first and fourth leg portions 48a, 48d to improve the ability to control the quality of the electric machine modules 10.

In some embodiments, the twisting process can be at least partially provided by conductors 44 of different configurations. In some embodiments, the leg portions 48 of at least some of the conductors 44 can comprise different sizes. For example, the conductors 44 can be disposed in the slots 42 so that one leg portion 48 can comprise the first leg portion 48a in a first slot 42 and that the other leg portion 48 can comprise the second leg portion 48b in a second slot 42. Additionally, another conductor 44 can be disposed in the same slots so that one of its leg portions 48 comprises the second leg portion 48b in the first slot 42 and the first leg portion 48a in the second slot 42. Further, additional conductors can be disposed in the first and second slots 42 so that their leg portions 48 comprise the third and fourth leg portions 48c, 48d in a similar manner. Furthermore, some or all of the remaining slots 42 can receive leg portions 48 in a similar configuration.

In some embodiments, at least a portion of the conductors 44 can comprise leg portions 48 of different sizes to provide for the greater extent of twisting of the first and fourth leg portions 48a, 48d and the lesser extent of twisting of the second and third leg portions 48b, 48c. In some embodiments, the conductors 44 can comprise leg portions 48 of greater and lesser sizes (e.g., lengths) to accommodate the twisting process. For example, some of all of the conductors 44 can comprise one leg portion 48 of a greater length and one leg portion 48 of a lesser length. In some embodiments, the leg portion 48 of greater length can be disposed in the slots 42 so that it comprises the first or fourth leg portions 48a, 48d (i.e., one of the leg portions 48 that is twisted to a greater extent). Moreover, in some embodiments, the leg portion 48 of lesser length can be disposed in slots 42 so that it comprises the second or third leg portions 48b, 48c (i.e., one of the leg portions 48 that is twisted to a lesser extent). As a result, the leg portions 48a-48d can be twisted according to some embodiments of the invention and can form the clearance aperture 45a-45d, as previously mentioned.

In some embodiments, the conductors 44 can comprise other configurations. In some embodiments, the conductors 44 can comprise a substantially conventional configuration (e.g., some or all of the conductors 44 include leg portions 48 of substantially similar length) and the leg portions 48 can be modified prior to and/or after the twisting process. For example, after positioning the leg portions 48 within some or all of the slots 42, but before twisting, some or all of the second and third leg portions 48b, 48c can be modified (e.g., cut, melted, or otherwise reduced in length) so that the leg portions 48b, 48c comprise a lesser length to provide for the reduced extent of twisting. In other embodiments, after positioning the leg portions 48 within some or all of the slots 42 and performing the twisting process, some or all of the second and third leg portions 48b, 48c can be modified to remove some or all of the excess length of the leg portions 48b, 48c prior to coupling of the connection portions 64.

As shown in FIG. 1, in some embodiments, the sleeve member 14 can comprise a coolant jacket 66. For example, in some embodiments, the sleeve member 14 can include an inner wall 68 and an outer wall 70 and the coolant jacket 66 can be positioned substantially between the walls 68, 70. In some embodiments, the coolant jacket 66 can substantially circumscribe at least a portion of the electric machine 20. More specifically, in some embodiments, the coolant jacket 66 can substantially circumscribe at least a portion of an outer perimeter 43 of the stator assembly 26, including the stator winding 36 as it extends on both the insertion end 56 and the weld end 58 (e.g., the stator end turns 54).

Further, in some embodiments, the coolant jacket 66 can contain a coolant that can comprise transmission fluid, ethylene glycol, an ethylene glycol/water mixture, water, oil, motor oil, a mist, a gas, or another substance capable of receiving heat energy produced by the electric machine module 10. The coolant jacket 66 can be in fluid communication with a coolant source (not shown) which can pressurize the coolant prior to or as it is being dispersed into the coolant jacket 66, so that the pressurized coolant can circulate through the coolant jacket 66.

Also, in some embodiments, the inner wall 68 can include coolant apertures 72 so that the coolant jacket 66 can be in fluid communication with the machine cavity 22. In some embodiments, the coolant apertures 72 can be positioned substantially adjacent to the stator end winding 36 as it exits the stator core 34 on at least one of the weld end 58 and the insertion end 56. For example, in some embodiments, as the pressurized coolant circulates through the coolant jacket 66, at least a portion of the coolant can exit the coolant jacket 66 through the coolant apertures 72 and enter the machine cavity 22. Also, in some embodiments, the coolant can contact the stator winding 36, which can lead to at least partial cooling. After exiting the coolant apertures 72, at least a portion of the coolant can flow through portions of the machine cavity 22 and can contact various module 10 elements, which, in some embodiments, can lead to at least partial cooling of the module 10.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a stator assembly including a stator core, the stator core further comprising a plurality of slots;
a plurality of conductors being at least partially disposed within the plurality of slots, each of the plurality of conductors comprising one or more leg portions, the plurality of conductors being disposed within the plurality of slots so that at least some of the plurality of slots include a first leg portion, a second leg portion, a third leg portion, and fourth leg portion extending from an end of the stator core; and
a plurality of first clearance apertures defined between circumferentially adjacent first leg portions, a plurality of second clearance apertures defined between circumferentially adjacent second leg portions, a plurality of third clearance apertures defined between circumferentially adjacent third leg portions, and a plurality of fourth clearance apertures defined between circumferentially adjacent fourth leg portions, and wherein at least a portion the second and third clearance apertures comprise a greater circumferential size relative to at least a portion of the first and fourth clearance apertures.

2. The electric machine module of claim 1, wherein the first leg portions are substantially adjacent to an inner perimeter of the stator core and the fourth leg portions are substantially adjacent to an outer perimeter of the stator core.

3. The electric machine module of claim 2, wherein the second leg portions are immediately radially adjacent to at least some of the first leg portions and the third leg portions are immediately radially adjacent to at least some of the second leg portions.

3. The electric machine module of claim 1, wherein the first clearance apertures and the fourth clearance apertures comprise a substantially similar circumferential size.

4. The electric machine module of claim 3, wherein the second and third clearance apertures comprise a substantially similar circumferential size.

5. The electric machine module of claim 1, wherein the second leg portions and third leg portions are disposed in radially inward positions and the first leg portions and the fourth leg portions are disposed in radially outward positions.

6. The electric machine module of claim 5, wherein the first and fourth clearance apertures are easier to inspect than the second and third clearance apertures.

7. The electric machine module of claim 1, wherein the stator assembly is at least partially disposed within a housing defining a machine cavity.

8. The electric machine module of claim 7, and further comprising a coolant jacket at least partially defined by the housing.

9. A method of assembling an electric machine module, the method comprising:
assembling a stator core comprising a plurality of slots;
inserting a plurality of conductors within at least some of the plurality of slots, each of the plurality of conductors comprising one or more leg portions, wherein the plurality of conductors are disposed within the plurality of slots so that at least some of the plurality of slots include a first leg portion, a second leg portion, a third leg portion, and fourth leg portion extending from an end of the stator core; and
twisting at least some of the first leg portions in a first direction to define a plurality of first clearance apertures between circumferentially adjacent first leg portions;
twisting at least some of the second leg portions in a second direction to define a plurality of second clearance apertures between circumferentially adjacent second leg portions;
twisting at least some of the third leg portions in the first direction to define a plurality of third clearance apertures between circumferentially adjacent third leg portions; and
twisting at least some of the fourth leg portions in the second direction to define a plurality of fourth clearance apertures between circumferentially adjacent fourth leg portions, and wherein at least one of the first clearance apertures and fourth clearance apertures comprise a lesser circumferential size relative to at least one of the second clearance apertures and third clearance apertures.

10. The method of claim 9 and further comprising defining one or more connection portions at axial ends of at least some of the leg portions.

11. The method of claim 10 and further comprising coupling together at least a portion of the connection portions of the first and second leg portions and coupling together at least a portion of the connection portions of the third and fourth leg portions.

12. The method of claim 9, wherein at least a portion of the first and the fourth clearance apertures are configured and arranged to enable inspection.

13. The method of claim 9 and further comprising positioning the stator core at least partially within a machine cavity defined by a housing.

14. The method of claim 13 and further comprising positioning a coolant jacket at least partially within the housing.

15. The method of claim 9, wherein the first clearance apertures and the fourth clearance apertures comprise a substantially similar circumferential size and the second clearance apertures and the third apertures comprise a substantially similar circumferential size.

16. The method of claim 9, wherein the first direction is a substantially clockwise direction and the second direction is a substantially counter-clockwise direction.

17. The method of claim 9, wherein at least some of the first leg portions and the fourth leg portions are twisted a distance substantially similar to a length of four adjacent slots and the second leg portions and the third leg portions are twisted a distance substantially similar to a length of two adjacent slots.

18. A method of assembling an electric machine module, the method comprising:
providing a stator core including a plurality of slots, the stator core including a weld end;
inserting a plurality of conductors within at least some of the plurality of slots, each of the plurality of conductors comprising a turn portion disposed between two leg portions, wherein the plurality of conductors are disposed within the plurality of slots so that a first leg portion, a second leg portion, a third leg portion, and fourth leg portion extend from the stator core at the weld end;
defining a plurality of first clearance apertures between circumferentially adjacent first leg portions;
defining a plurality of second clearance apertures between circumferentially adjacent second leg portions;
defining a plurality of third clearance apertures between circumferentially adjacent third leg portions; and
defining a plurality of fourth clearance apertures between circumferentially adjacent fourth leg portions, and wherein at least one of the first clearance apertures and the fourth clearance apertures comprises a lesser size relative to at least one of the second clearance apertures and the third clearance apertures.

19. The method of claim 18, wherein at least a portion of the first and the fourth clearance apertures are configured and arranged to enable visual inspection.

20. The method of claim 18, wherein the first and fourth clearance apertures comprise a substantially similar size and the second and third clearance apertures comprise a substantially similar size.
